(19) United States
(12) Patent Application Publication
(10) Pub. No.: US 2016/0146442 A1
(43) Pub. Date: May 26, 2016

(54) LAMP

(71) Applicant: HON HAI PRECISION INDUSTRY CO., LTD., New Taipei (TW)

(72) Inventor: CHI-HSIEN FONG, New Taipei (TW)

(21) Appl. No.: 14/805,886

(22) Filed: Jul. 22, 2015

(30) Foreign Application Priority Data
Nov. 25, 2014 (CN) 201410685456.6

(51) Int. Cl. F21V 23/06; F21V 3/00; F21V 19/00

(52) U.S. Cl. CPC F21V 23/06; F21V 19/0045; F21V 19/0035; F21V 3/00

(57) ABSTRACT

A lamp includes a lamp holder, a print circuit board, and the light source assembly. The print circuit board is mounted on the lamp holder. The print circuit board includes a main body and two conductive poles electrically coupled with the main body. The light source assembly is mounted on the lamp holder. The light source assembly includes a lamp board mounted on the lamp holder and a light emitting element. The light source includes a board body and two conductive pieces. The board body separately defines two first through holes, each conductive pole passes through one first through hole. One end of each conductive piece passes through one first through hole and electrically coupled to a corresponding one conductive pole. The light emitting element is mounted on the board body and electrically coupled to another end of each conductive piece.

### FIELD

The subject matter herein generally relates to a lamp.

### BACKGROUND

Lamps, especially for LED lamps, are widely used for lighting, decoration.

Conductive wires are used to electrically couple between a print circuit board and a lamp board in lamps. However, the conductive wires are easily to be broken, caused by times of bending for tests or assemblies.

### BRIEF DESCRIPTION OF THE DRAWINGS

Implementations of the present technology will now be described, by way of example only, with reference to the attached figures.

FIG. 1 illustrates a cross-sectional view for a lamp including a lamp board and a light source assembly in one embodiment.

FIG. 2 illustrates an exploded view of the lamp board and the light source assembly of the lamp of FIG. 1.

FIG. 3 is a partial, exploded view of the lamp board coupling to the light source assembly of the lamp of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact.

For example, “substantially cylindrical” means that the object resembles a cylinder, but can have one or more deviations from a true cylinder. The term “comprising,” when utilized, means “including, but not necessarily limited to;” it specifically indicates open-ended inclusion or membership in the so-described combination, group, series and the like.

The present disclosure is described in relation to a lamp. The lamp includes a lamp holder, a print circuit board, and the light source assembly. The print circuit board is mounted on the lamp holder. The print circuit board includes a main body and two conductive poles electrically coupled with the main body. The light source assembly is mounted on the lamp holder. The light source assembly includes a lamp board mounted on the lamp holder and a light emitting element. The light source includes a board body and two conductive pieces. The board body separately defines two first through holes, each conductive pole passes through one first through hole. One end of each conductive piece passes through one first through hole and electrically coupled to a corresponding one conductive pole. The light emitting element is mounted on the board body and electrically coupled to another end of each conductive piece

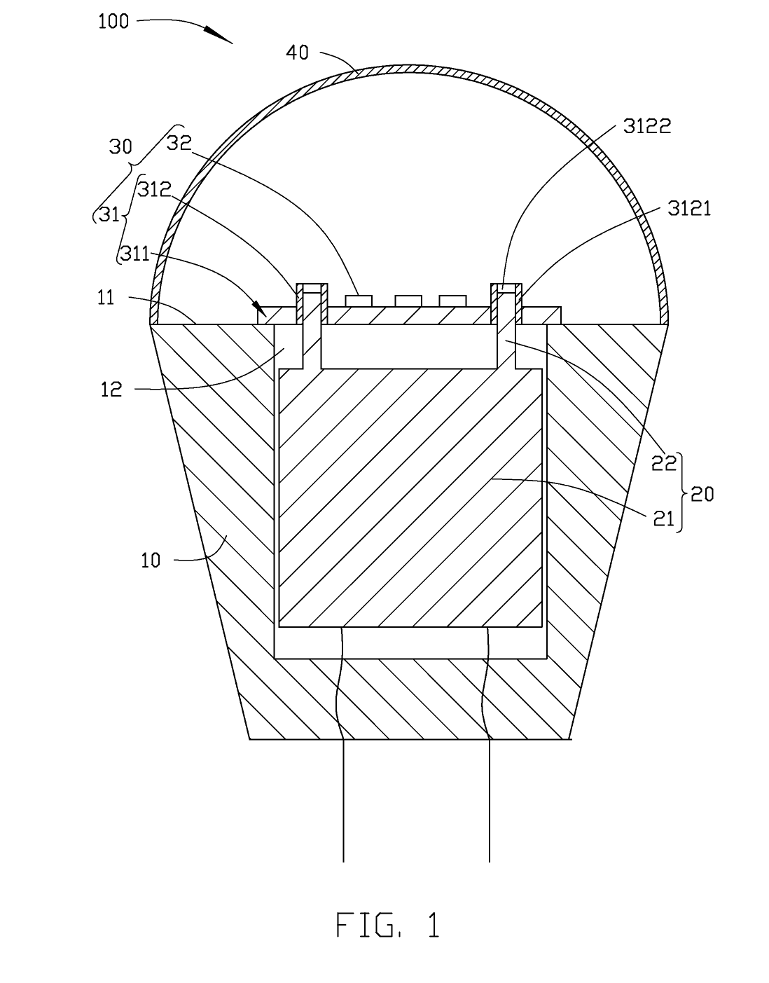

FIG. 1 illustrates a lamp 100 for lighting. The lamp 100 can include a lamp holder 10, a print circuit board 20, a light source assembly 30, and a light transmission cover 40. The print circuit board 20, the light source assembly 30 and the light transmission cover 40 can be positioned on the lamp holder 10. The print circuit board 20 and the light source assembly 30 can be received in the light transmission cover 40.

The lamp holder 10 can form a mounting surface 11. The mounting surface 11 can define a receiving groove 12.

The print circuit board 20 can be mounted and received in the receiving groove 12. The print circuit board 20 can include a main body 21 and two conductive poles 22. A circuit (not shown) can be formed on the print circuit board 20. The two conductive poles 22 respectively electrically coupled with the circuit of the main body 21. The two conductive poles 22 can extend from a side surface of the main body 21 for electrically coupling to the light source assembly 30. A coupler (not shown) can be formed on the main body 21 for coupling to an external power source for supplying electric power.

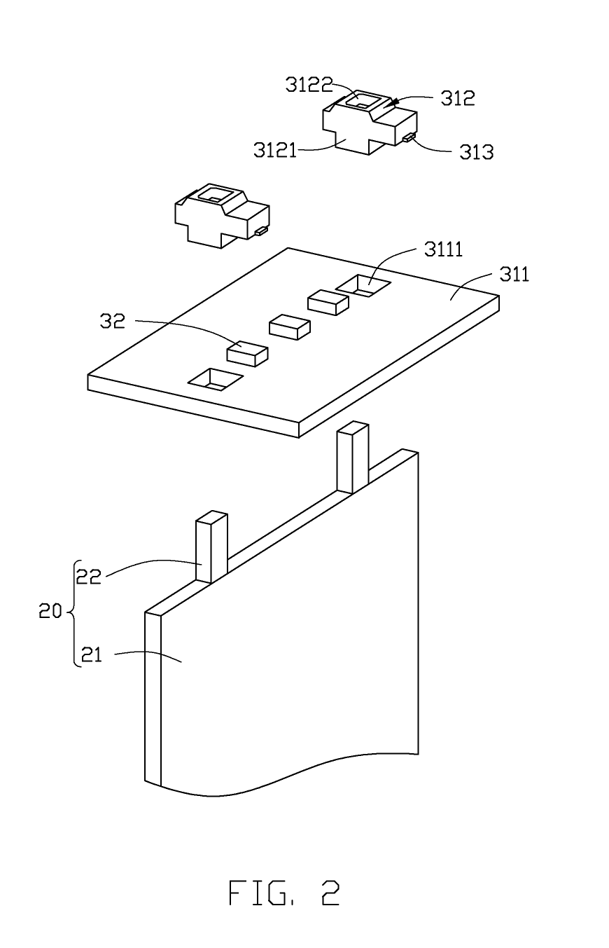

Also referring to FIG. 2, the light source assembly 30 can include a lamp board 31 and a plurality of light emitting elements 32. The lamp board 31 can be mounted on the mounting surface 11. The plurality of light emitting elements 32 can be mounted on the lamp board 31 away from the mounting surface 11 and electrically couple to each other.

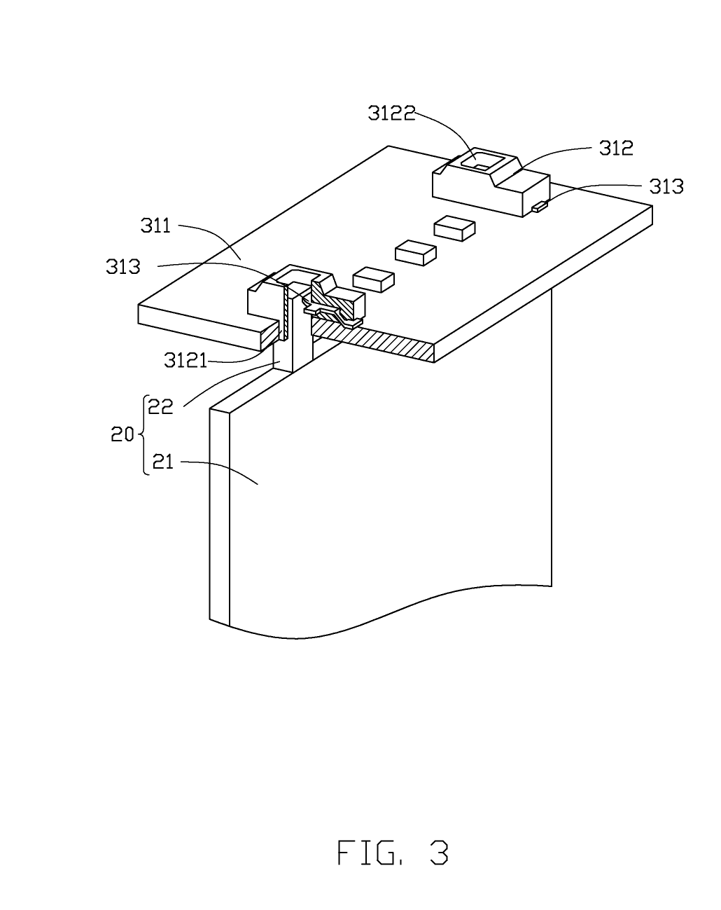

Also referring to FIG. 3, the lamp board 31 can include a board body 311, two connecting members 312, and two conductive pieces 313. The board body 311 can be mounted on the mounting surface 11 via several methods, for example, a bolt is used to the board body 311 to the mounting surface 11. The board body 311 can separately define two first through holes 3111 corresponding to the two conductive poles 22. The two conductive pieces 313 can be mounted on the connecting member 312.

In other embodiments, a plurality of heat sinks (not shown) can be positioned on the mountings surface 11 for cooling. The board body 311 can be mounted on the plurality of heat sinks for cooling.

Each connecting member 312 can be substantially a square-shaped. The connecting member 312 can be insulative. The connecting member 312 can be positioned on a side of the board body 311 away from the main body 21. A protrusion 3121 can be formed on a sidewall of each connecting member 312 towards the board body 311. Each protrusion 3121 can be received in one first through hole 3111. A second through hole 3122 can be formed on each protrusion 3121. Each conductive pole 22 can be received in one second through hole 3122.

The conductive piece 313 can be a non-planar piece. Each conductive piece 313 can be positioned in one connecting member 312. One end of each conductive piece 313 can extend into the second through hole 3122 to electrically couple with the plurality of light emitting elements 32. The conductive pieces 313 can be elastic pieces. Each conductive pole 22 can extend into one second through hole 3122 and contact with the corresponding one conductive piece 313.

The plurality of light emitting elements 32 can be electrically coupled to each other. The plurality of light emitting elements 32 can be electrically coupled to another end of each conductive piece 313, which exposed out of the connecting member 312.

In other embodiments, the connecting member 312 of the lamp board 31 can be omitted, one end of each conductive piece 313 can be fixed on the board body 311 and electrically coupled to the plurality of light emitting elements 32, another end of each conductive piece 313 can electrically couple to one conductive pole 22 extending into corresponding one first through hole 3111.

In other embodiments, the number of the conductive pole 22 is not limited to two, just the print circuit board 20 can be electrically coupled to the plurality of light emitting elements 32. The number of the connecting members 312 and the number of the conductive pieces 313 are corresponding to the number of the conductive pole 22. The number of the light emitting element 32 can be one.

In other embodiments, the light transmission cover 40 can be omitted. A shape or a model of the lamp 100 is not limited.

In assembly, the protrusions 3121 of each connecting member 312 can be inserted into one first through holes 3111. One end of each conductive piece 313 exposed out of the connecting member 312 can be welded on the board body 311, and electrically coupled to the plurality of light emitting elements 32. The print circuit board 20 can be fixed in the receiving groove 12. The board body 311 can be mounted on the mounting surface 11. Each conductive pole 22 can pass through the corresponding second through hole 3122 and contacting with the end extending into the corresponding second through hole 3122 of one conductive piece 313. The light transmission cover 40 mounted on the mounting surface 11 for covering the print circuit board 20 and the light source assembly 30.

In use, the lamp 100 can emit light when the coupler is electrically coupled to the external power source.

The conductive pieces 312 can be embedded in the connecting members 312, welded with the board body 311, and electrically coupled to the light emitting elements 32, such that the conductive poles 22 of the print circuit board 20 can be electrically coupled to the conductive pieces 313 for electrically coupling the light emitting elements 32.

The embodiments shown and described above are only examples. Many details are often found in the art such as the other features of a lamp. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A lamp comprising:
a lamp holder;
a print circuit board mounted on the lamp holder and comprising:
a main body; and
two conductive poles, each of the two conductive poles being individually electrically coupled to the main body;
a light source assembly mounted on the lamp holder and comprising:
a lamp board mounted on the lamp holder, the lamp board comprising a board body separately defining two first through holes, each of the two conductive poles passing through one corresponding first through hole; and
two conductive pieces, one end of each of the two conductive pieces passing through one first through hole and electrically coupled to a corresponding one conductive pole; and
a light emitting element mounted on the board body and electrically coupled to another end of each of the two conductive pieces.

2. The lamp of claim 1, wherein the lamp board further comprises two connecting members, each of the two connecting members is positioned on a side of the board body away from the main body, a protrusion is formed on a sidewall of the two connecting members towards the board body, the protrusion is received in one first through hole, a second through hole is formed each protrusion, each of the two conductive pieces is positioned in one connecting member and extends into the second through hole to electrically couple with the light emitting element, each of the two conductive poles extends into one second through hole and contact with the corresponding one conductive piece.

3. The lamp of claim 2, wherein a portion of each conductive piece exposed out of the second through hole is welded with the board body for fixing the connecting members, the conductive pieces together with the board body.

4. The lamp of claim 2, wherein the lamp holder forms a mounting surface, the mounting surface defines a receiving groove, the print circuit board is mounted and received in the receiving groove, the light source assembly is positioned on the mounting surface.

5. The lamp of claim 1, wherein the lamp comprises a light transmission cover mounted on the lamp holder for covering the print circuit board and the light source assembly.

6. A lamp, comprising:
a lamp holder;
a print circuit board mounted on the lamp holder comprising two conductive poles;
a light source assembly mounted on the lamp holder, comprising:
a board body mounted on the lamp holder and separately defining two first through holes; and
two elastic conductive pieces, each of the two elastic conductive pieces passing through one first through hole; and
a light emitting element mounted on the board body,
wherein each of the two conductive poles passing through one first through hole and contacting with a corresponding one elastic conductive piece, a portion of each of the two elastic conductive pieces away from the corresponding one conductive pole is electrically coupled to the light emitting element, such that the print circuit board is electrically coupled to the light emitting element.

7. The lamp of claim 6, wherein the lamp board further comprises two connecting members, each of the two connecting members is positioned on a side of the board body away from the main body, a protrusion is formed on a sidewall of each of the two connecting members towards the board body, the protrusion is received in one first through hole, a second through hole is formed each protrusion, each of the two conductive pieces is positioned in one connecting member and extends into the second through hole to electrically couple with the light emitting element, each of the two conductive poles extends into one second through hole and contact with the corresponding one conductive piece.

8. The lamp of claim 7, wherein a portion of each conductive piece exposed out of the second through hole is welded with the board body for fixing the connecting members, the conductive pieces together with the board body.

9. The lamp of claim 7, wherein the lamp holder forms a mounting surface, the mounting surface defines a receiving groove, the print circuit board is mounted and received in the receiving groove, the light source assembly is positioned on the mounting surface.

10. The lamp of claim 6, wherein the lamp comprises a light transmission cover mounted on the lamp holder for covering the print circuit board and the light source assembly.
